(19) United States
(12) Patent Application Publication
(10) Pub. No.: US 2012/0085666 A1
(43) Pub. Date: Apr. 12, 2012

(54) GOLF BAG AND ATTACHMENT THEREFOR

(76) Inventor: Bob McGuire, Orland Park, IL (US)

(21) Appl. No.: 13/267,447

(22) Filed: Oct. 6, 2011

Related U.S. Application Data
(60) Provisional application No. 61/391,368, filed on Oct. 8, 2010.

(51) Int. Cl. A63B 55/00; A63B 71/00; B23P 11/00

(52) U.S. Cl. 206/315.3; 29/428; 248/96

(57) ABSTRACT

A golf bag includes a housing having a side wall and a bottom wall and a strap receiver attached to the side wall. The strap receiver includes an outer wall connecting opposing receiver side walls, wherein the receiver side walls are attached to the golf bag. The strap receiver further includes first and second open ends formed by the outer wall and the receiver side walls and forming an opening perpendicular to a longitudinal axis of the golf bag, wherein the opening is adapted for insertion of a strap therein.

### CROSS REFERENCE TO RELATED APPLICATIONS

This application claims the benefit of U.S. Provisional Patent Application Ser. No. 61/391,368, filed on Oct. 8, 2010, and entitled “Golf Bag Attachment Mechanism,” the content of which is incorporated herein by reference in its entirety.

### BACKGROUND

The present disclosure relates to golfing, and in particular, to golf bags. More particularly, the present disclosure relates to golf bag attachment mechanisms.

### SUMMARY

A golf bag, in accordance with the present disclosure, includes a housing provided with a series of openings that are adapted to accept the shafts of golf clubs. The housing includes side walls and a bottom wall. The housing may also include one or more pockets adapted to hold golf accessories.

In illustrative embodiments, the golf bag is adapted to be secured to a golf car by use of a golf cart strap and includes a side wall having front and rear portions, and a bottom wall that form an interior chamber of the bag. The golf bag includes a first strap receiver having a passageway provided with a first open end and a second open end. The first strap receiver is positioned on the side wall of the golf bag and is configured to accept the golf cart strap.

The golf bag also includes a second strap receiver having a passageway provided with a first open end and a second open end. The second strap receiver is positioned on the side wall of the golf bag opposite the first strap receiver. The first and second strap receivers are configured to allow the golf cart strap to enter into the passageway of first strap receiver around the rear portion of the side wall to passageway of the second strap receiver. Once the golf car strap is coupled to both strap receivers, the strap can be pulled tight to secure the golf bag to the golf cart.

In illustrative embodiments, the rear portion of the side wall includes a friction material to reduce movement of the side wall with respect to the golf cart strap. The first and second strap receivers are configured to include an interior surface and an exterior surface. The interior surfaces of the first and second strap receivers are formed to include a series of finger grooves that are configured to accept the fingers of the user to allow the first and second strap receivers to be used as handles to permit a user to carry the golf bag. The first and second strap receivers include an outer wall and a pair of side walls that extend outwardly from the outer wall the side walls each include a flange that is configured to be coupled to the side wall of the golf bag by use of fasteners. The first and second strap receivers are over molded with a material to provide a more hand grip type feel.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a golf bag secured to a golf cart by use of a golf cart strap in accordance with the present disclosure;

FIG. 2 is an enlarged perspective view of the golf bag showing the golf cart strap passing through a first embodiment of a strap receiver and extending around the rear portion of the bag;

FIG. 3 is a an enlarged perspective view of the golf bag showing a strap receiver and friction material attached to a side wall of the golf bag;

FIG. 4 is a top view of the first embodiment of the strap receiver;

FIG. 5 is a side view of the first embodiment of the strap receiver;

FIG. 6 is an exploded view of the first embodiment of the strap receiver being coupled to the side wall of the golf bag;

FIGS. 7 and 8 are side elevational views of a second embodiment of a strap receiver attached to opposing sides of a golf bag;

FIG. 9 is a front isometric view of the strap receivers of FIGS. 7 and 8; and

FIG. 10 is a side isometric view of the strap receivers of FIGS. 7 and 8.

### DETAILED DESCRIPTION

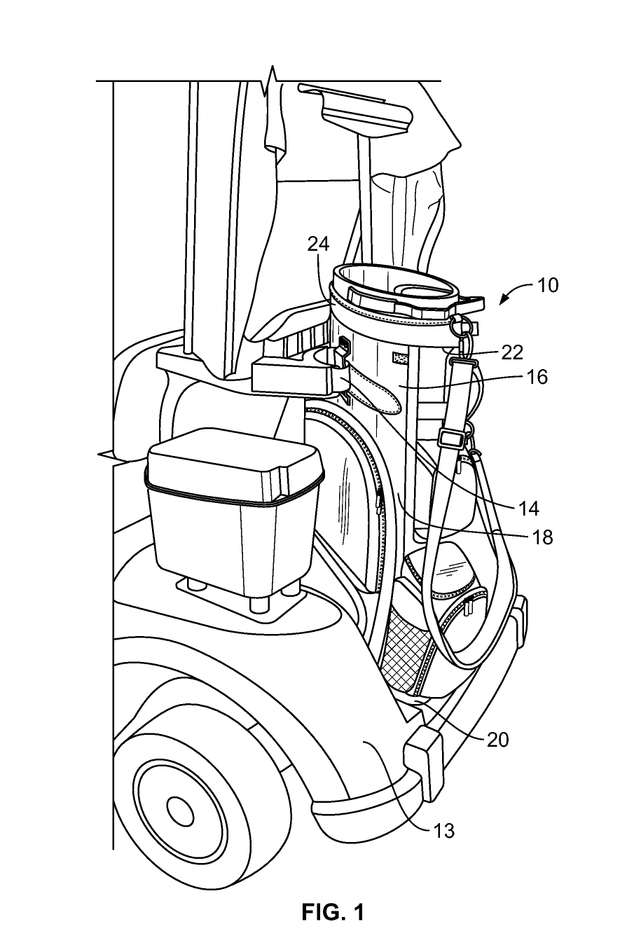

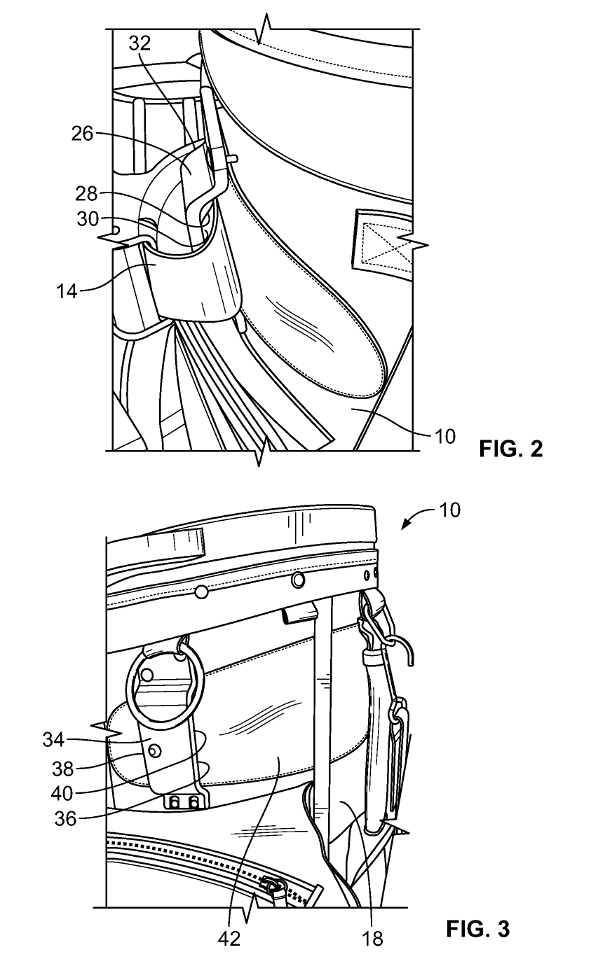

A golf bag 10 is shown coupled to a golf cart 13 by use of a golf cart strap 14, as shown, for example, in FIGS. 1 and 2. Golf bag 10 includes a housing 16. Housing 16 of golf bag 10 includes a side wall 18 and bottom wall 20. Side wall 18 includes a front portion 22 and a rear portion 24. The golf bag 10 includes a first strap receiver 26 having a passageway 28 provided with a first open end 30 and a second open end 32. The first strap receiver 26 is positioned on the side wall 18 of the golf bag 10 and is configured to accept the golf cart strap 14. The passageway 28 of the first strap receiver 26 forms a horizontal passageway to allow for the passage of the golf cart strap 14. The first strap receiver 26 also functions as a handle to allow a user to carry the golf bag 10.

The golf bag 10 also includes a second strap receiver 34 having a passageway 36 provided with a first open end 38 and a second open end 40, as shown, for example, in FIG. 3. The second strap receiver 34 is positioned on the side wall 18 of the golf bag 10 opposite the first strap receiver 26. The first and second strap receivers 26, 34 are configured to allow the golf cart strap 14 to enter into the passageway 28 of first strap receiver 26 around the rear portion 24 of the side wall 18 to the passageway 36 of the second strap receiver 34 or into the passageway 36 of the second strap receiver 34 around the rear portion 24 of the side wall 18 to the passageway 28 of the first receiver strap 26. In both cases, once the golf car strap 14 is positioned within both strap receivers 26, 34, the strap 14 can be pulled tight to secure the golf bag 10 to the golf cart 13.

The rear portion 24 of the side wall 18 includes a friction material 42, as shown, for example, in FIG. 3. Friction material 42 is configured to reduce movement of the golf cart strap 14 with respect to the side wall 18 so that the golf bag 10 does not move around when secured to the golf cart 13. The first and second strap receivers 26, 34 are configured to include an interior surface 44 and an exterior surface 46. The interior surfaces 46 of the first and second strap receivers 26, 34 are formed to include a series of finger grooves 48 that are configured to accept the fingers of the user to allow the first and second strap receivers 26, 34 to be used as handles to permit a user to carry the golf bag 10. In addition, the strap receivers 26, 34 may be utilized as side lifts.

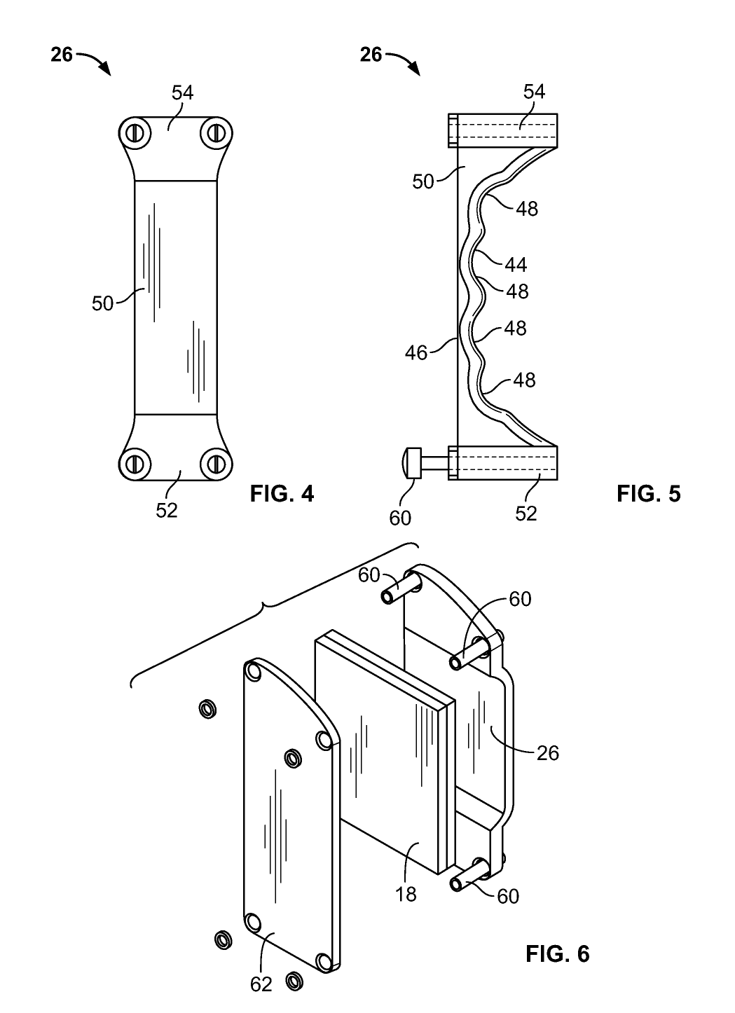

The first and second strap receivers 26, 34 include an outer wall 50 and a pair of side walls 52, 54 that extend outwardly from the outer wall 50, as shown, for example, in FIGS. 4-6. The side walls 52, 54 are configured to be coupled to the side wall 18 of the golf bag 10 by use of fasteners 60. Fasteners 60 extend through side wall 18 of golf bag 10 and are secured to a backing plate 62. The backing plate 62 is shown in FIG. 6 as being disposed within an interior of the golf bag 10, but the backing plate 62 may optionally be disposed within the material forming the golf bag 10 so that the plate 62 is not visible. Backing plate 62 is used to prevent first and second strap receivers 26, 34 from pulling out of the side wall 18 of the golf bag 10. The first and second strap receivers 26, 34 are over molded with a thermoplastic elastomer (TPE) material to provide a grip that is comfortable to the touch.

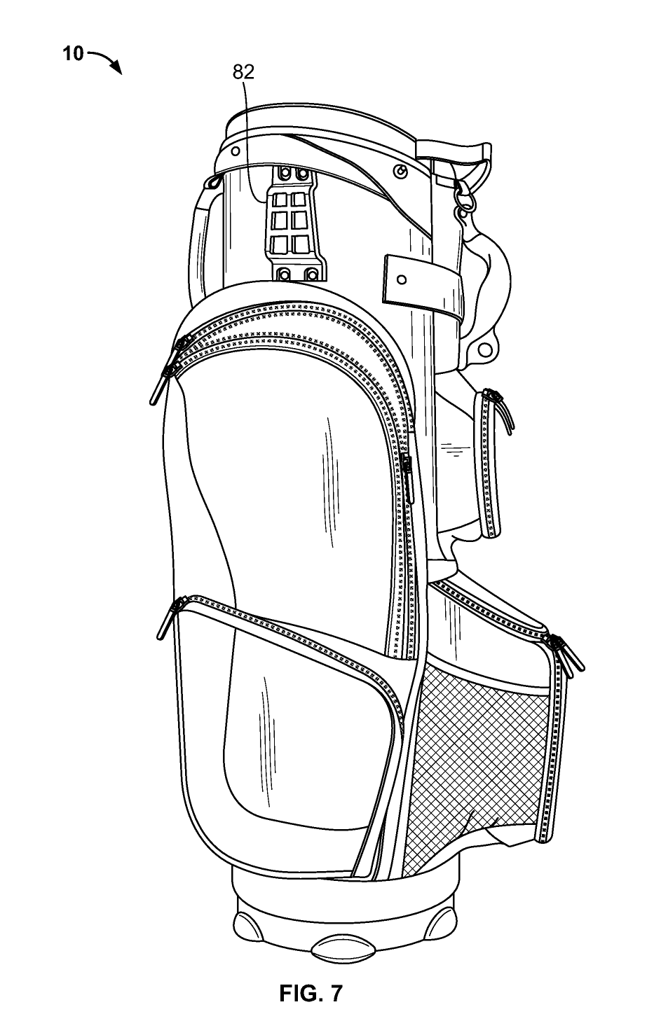

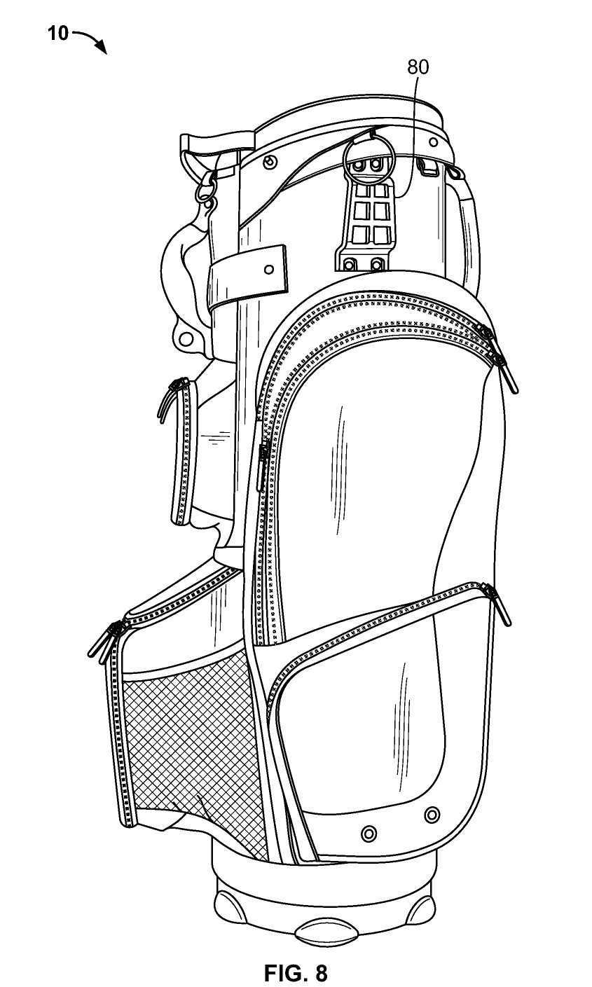

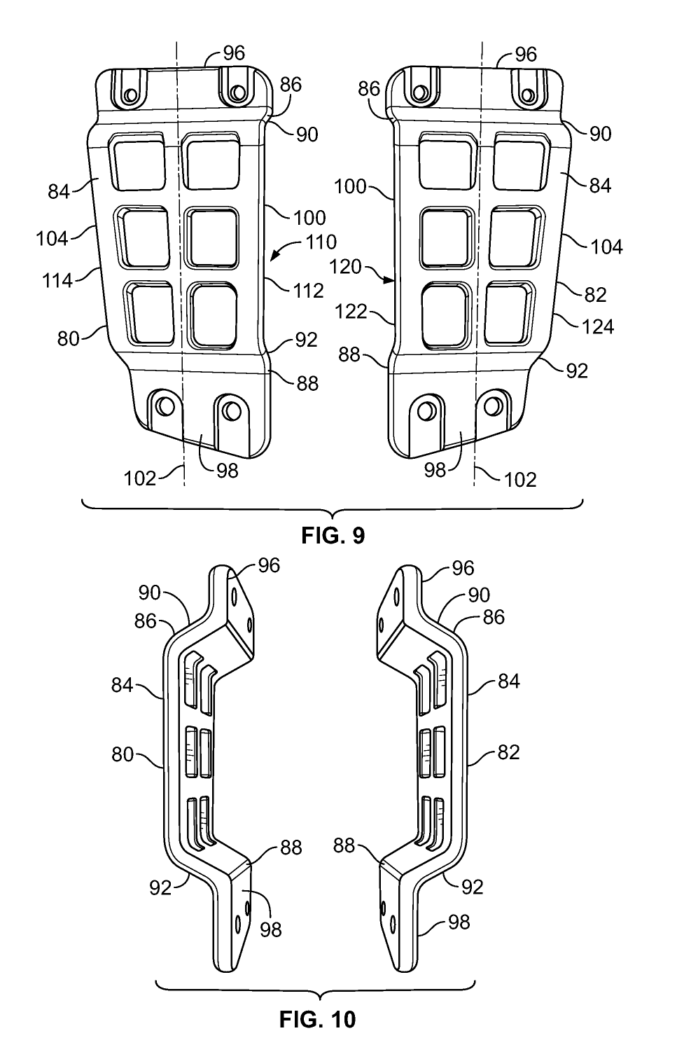

A further embodiment of strap receivers 80, 82 of the present disclosure are depicted in FIGS. 7-10. Each of the receivers 80, 82 includes an outer wall 84 and a pair of side walls 86, 88 that extend outwardly from the outer wall 84, as best seen in FIGS. 9 and 10. The side walls 86, 88 are generally L-shaped with a first wall portion 90, 92 disposed at an angle with respect to the outer wall 84 and a second wall portion 96, 98 that is disposed at an angle with respect to the first wall portion 90, 92 and is generally parallel to the outer wall 84. The second wall portions 96, 98 are configured to couple the receivers 80, 82 to a side wall 18 of the golf bag 10 in the same manner as discussed hereinabove. Referring to FIGS. 7-9, each the outer walls 84 includes a first side edge 100 that is generally parallel to a longitudinal axis 102 of the receiver 80, 82 and a second side edge 104 that is disposed at an angle with respect to the longitudinal axis 102. The strap receivers 80, 82 are disposed slightly higher than the golf cart strap 14 and portions of the golf cart to which the strap 14 is attached. The angle formed by the second side edge 104 therefore provides a more secure and untangled connection of the strap 14 to the strap receives 80, 82 and allows for ease in tightening the strap 14.

Similar to the previous embodiment, and as best seen in FIG. 9, a first strap receiver 80 includes a passageway 110 formed by the outer wall 84 and side walls 86, 88, the passageway 110 having a first open end 112 and a second open end 114. The first strap receiver 80 is positioned on the side wall 18 of the golf bag 10 and is configured to accept the golf cart strap 14. The passageway 110 of the first strap receiver 80 forms a generally horizontal passageway to allow for passage of the golf cart strap 14. The first strap receiver 80 also functions as a handle to allow a user to carry the golf bag 10.

The second strap receiver 82 includes a passageway 120 with a first open end 122 and a second open end 124, as shown in FIG. 9. The second strap receiver 120 is positioned on the side wall 18 of the golf bag 10 opposite the first strap receiver 82 in the same manner as discussed with respect to the first embodiment. The first and second strap receivers 80, 82 are configured to allow the golf cart strap 14 to enter into the passageway 110 of first strap receiver 80 around the rear portion 24 of the side wall 18 of the golf bag 10 to the passageway 120 of the second strap receiver 82 or into the passageway 120 of the second strap receiver 82 around the rear portion 24 of the side wall 18 to the passageway 110 of the first receiver strap 80. In both cases, once the golf car strap 14 is positioned within both strap receivers 26, 34, the strap 14 can be pulled tight to secure the golf bag 10 to the golf cart 13. In either case, a friction material may be disposed on the golf bag 10, as discussed in detail above, to aid in securing and stabilizing the golf bag 10. Although two strap receivers 80, 82 are shown, more than two strap receives 80, 82 may be utilized, for example, with a golf bag having a larger diameter or for a more secure connection.

Various features of the disclosure have been shown and described in connection with the illustrated embodiment, however, it is understood that these arrangements merely illustrate, and that the disclosure is to be given its fullest interpretation.

Although directional terminology, such as horizontal, front, back, etc. may be used throughout the present specification, it should be understood that such terms are not limiting and are only utilized herein to convey the orientation of different elements with respect to one another.

I claim:

1. A golf bag, comprising:
a housing having a side wall and a bottom wall; and
a strap receiver attached to the side wall and including
an outer wall connecting opposing receiver side walls, wherein the receiver side walls are attached to the golf bag; and
first and second open ends formed by the outer wall and the receiver side walls and forming an opening generally perpendicular to a longitudinal axis of the golf bag, wherein the opening is adapted for insertion of a strap therein.

2. The golf bag of claim 1, wherein the strap receiver is attached to the side wall by fasteners that secure the strap receiver to the side wall of the golf bag.

3. The golf bag of claim 2, wherein the fasteners are secured to a backing plate on an interior of or within the material of the golf bag to prevent the strap receiver from pulling out of the side wall of the golf bag.

4. The golf bag of claim 1, further including a second strap receiver attached to the side wall of the golf bag opposite the first-named strap receiver.

5. The golf bag of claim 4, wherein the second strap receiver includes:
a second outer wall connecting second opposing receiver side walls, wherein the second receiver side walls are attached to the golf bag; and
third and fourth open ends formed by the second outer wall and the second receiver side walls and forming a second opening perpendicular to the longitudinal axis of the golf bag, wherein the second opening is adapted for insertion of a strap therein.

6. The golf bag of claim 5, wherein the first-named and second strap receivers are attached to the side wall by fasteners that extend through the side wall of the golf bag.

7. The golf bag of claim 6, wherein the fasteners are secured to respective backing plates on an interior of or within the material of the golf bag to prevent the respective strap receivers from pulling out of the side wall of the golf bag.

8. The golf bag of claim 1, wherein an interior surface of the strap receiver facing the golf bag includes a series of finger grooves.

9. The golf bag of claim 8, wherein interior surfaces of the first-named and second straps facing the golf bag include a series of finger grooves.

10. The golf bag of claim 5, further including a friction material on the side wall extending between the strap receivers.

11. The golf bag of claim 1, wherein the outer wall of the strap receiver includes at least one finger hole.

12. An attachment mechanism for securing a golf bag in place, the attachment mechanism comprising:
a receiver portion having an outer wall extending between opposing side walls;
a backing plate; and
a series of fasteners connecting the receiver portion and the backing plate;
wherein the outer wall has a longitudinal axis, a first side edge parallel to the longitudinal axis, and a second side edge disposed at an angle with respect to the longitudinal axis.

13. The attachment mechanism of claim 12, wherein an interior wall of the receiver portion includes finger grooves.

14. The attachment mechanism of claim 12, wherein the receiver portion is overmolded with a thermoplastic elastomer material.

15. The attachment mechanism of claim 12, wherein the outer wall of the strap receiver includes at least one finger hole.

16. The attachment mechanism of claim 12 attached to a golf bag.

17. The combination of claim 16, further including a second attachment mechanism attached to the golf bag opposite the first-named attachment mechanism.

18. A method of securing a golf bag, the method comprising the steps of:
placing a golf bag having first and second strap receivers adjacent a surface to which it is to be secured;
threading a strap through a first passageway within the first strap receiver;
wrapping the strap around a portion of the side wall;
threading the strap through a second passageway within the second strap receiver; and
tightening the strap.

19. The method of claim 18, wherein the wrapping step includes wrapping the strap around a portion of the side wall disposed closest the surface.

20. The method of claim 18, further including the step of causing friction between the strap and the golf bag to secure and retain the golf bag.
